(19) United States
(12) Patent Application Publication
(10) Pub. No.: US 2012/0148078 A1
(43) Pub. Date: Jun. 14, 2012

(54) METHOD AND HEARING DEVICE FOR SETTING FEEDBACK SUPPRESSION

(75) Inventors: Dirk Junius, Mohrendorf (DE); Stefan Petrausch, Erlangen (DE); Nadine Seubert, Erlangen (DE)

(73) Assignee: SIEMENS MEDICAL INSTRUMENTS PTE. LTD., SINGAPORE (SG)

(21) Appl. No.: 13/121,265

(22) PCT Filed: May 28, 2010
(86) PCT No.: PCT/EP2010/057387

§ 371 Date: Mar. 28, 2011

(30) Foreign Application Priority Data
Jul. 2, 2009 (DE) 10 2009 031 536.5

(51) Int. Cl. H04R 25/00

(52) U.S. Cl. 381/318

(57) ABSTRACT

A method and an associated hearing device are enabled for setting feedback suppression. The method includes determining feedback events, determining the frequency of the feedback events within a prescribed first period of time, and setting feedback suppression in accordance with the frequency of the feedback events. The hearing device is able to choose automatically between different feedback algorithms in accordance with the specific feedback situation so that an optimal sound and feedback quality can be achieved.

The invention relates to a method, disclosed in claim 1, for setting feedback suppression, to a computer-program product, disclosed in claim 5, for executing the method, and to a hearing device, disclosed in claim 6, having a feedback-suppression unit.

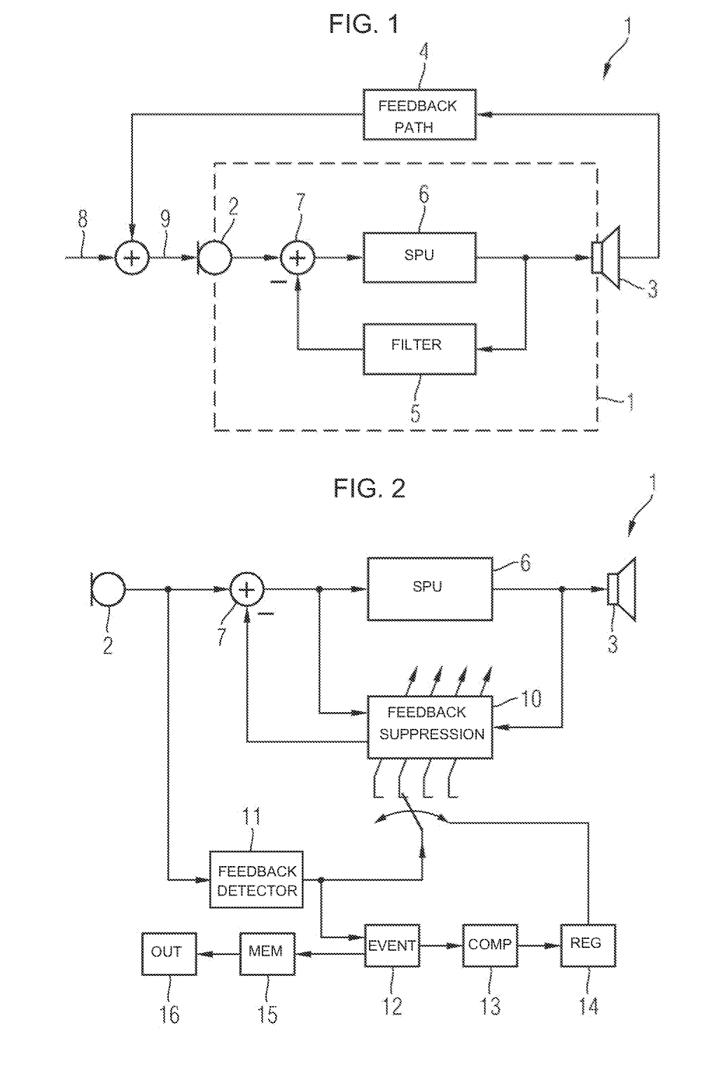

Feedback effects can occur if, for instance, there are cases of acoustic or electromagnetic coupling between the inputs and outputs in a hearing device. An arrangement presented schematically in FIG. 1 having a hearing aid 1 shows instances of acoustic feedback. An incident acoustic signal 9 is received by a microphone 2 belonging to hearing aid 1. Received signal 9 is inter alia edited and amplified in a signal-processing unit 6 and fed out as an acoustic signal again via an earpiece 3. Earpiece 3 is acoustically coupled back to microphone 2 via a physical feedback path 4. Received signal 9 therefore consists of the sum of an incident useful signal 8 and the signal of feedback path 4. Feedback can cause whistling if the signals are mutually overlying in phase. Sound artifacts can occur even earlier.

Physical feedback path 4 can be digitally simulated for suppressing the feedback effects. It is simulated with the aid of an adaptive compensation filter 5 fed from the earpiece signal. The earpiece signal is inverted after being filtered in adaptive compensation filter 5 and added to the microphone signal in an adder 7.

There will hence be two feedback paths in the system: Firstly, physically existing feedback path 4 and, secondly, the digital compensation path simulated via adaptive compensation filter 5. Because the two paths' resulting signals are subtracted one from the other, the effect of physical feedback path 4 will ideally be canceled out.

Hearing-aid manufacturers currently offer a plurality of settings for suppressing feedback. Although reacting quickly to changes in the feedback path, a “fast” setting will attack the useful signal and cause artifacts. While a “slow” setting will provide good sound quality when the feedback path is constant or changes only slowly, it cannot keep up with fast changes in the paths, which will in turn result in whistling.

Specialists in hearing-aid acoustics therefore have to decide on one of the offered settings when setting a hearing aid. Their decision is based on personal experience or on what the hearing-aid wearer has said. The result can be a less than optimal setting for feedback suppression. Moreover, the requirements placed on the feedback-suppression setting frequently change in the course of daily use. A “fast” setting will be preferred if the hearing-aid wearer wears a hat, for instance, or leans against a headrest. A “slow” setting will conversely be desirable in a concert hall.

The object of the invention is to disclose an improved method for suppressing feedback in a hearing device and a hearing device having improved feedback suppression.

Said object is inventively achieved by means of the method for setting feedback suppression as claimed in independent claim 1, by means of the computer-program product as claimed in independent claim 5, and by means of the hearing device having a feedback-suppression unit as claimed in independent claim 6.

The invention lays claim to a method for setting feedback suppression in a hearing device by determining feedback events, by determining the frequency of the feedback events within a pre-specifiable first period of time, and by setting feedback suppression in accordance with the frequency of the feedback events. That offers the advantage that the hearing device will be able to choose automatically between different feedback algorithms in accordance with the specific feedback situation so that an optimal sound and feedback quality can be achieved.

The feedback events can in a development of the invention be events where feedback suppression starts operating and/or where feedback is detected above a pre-specifiable feedback threshold.

In another embodiment variant the method can include pre-optimized parameter sets for setting feedback suppression. That will make it easy to switch between “fast” and “slow” feedback-suppression algorithms.

The method can furthermore include the following steps:
Determining the frequency of the feedback events within a pre-specifiable second period of time,
storing the frequency of the feedback events occurring within the pre-specifiable second period of time, and
outputting the stored frequency.
   What is advantageous therein is that a specialist in hearing-aid acoustics will during an adjustment session obtain information about the frequency of instances of feedback and be able to initiate measures for improvement, as a result of which customer satisfaction will be enhanced.

The invention lays claim also to a computer-program product having a computer program that has software means for executing the inventive method if the computer program is embodied in a control unit of a hearing device.

The invention lays claim also to a hearing device having a feedback-suppression unit that starts operating when acoustic feedback occurs, and/or has an acoustic feedback-detection unit. The hearing device further includes an event unit for determining feedback events, a computing unit for determining the frequency of the feedback events within a pre-specifiable first time interval, and a regulating unit for setting the feedback-suppression unit in accordance with the frequency of the feedback events.

The feedback events can in a development of the hearing device be events where feedback suppression starts operating and/or where feedback can be detected above a pre-specifiable feedback threshold.

In another embodiment variant the hearing device can include pre-optimized parameter sets for setting the feedback-suppression unit.

In a further embodiment the hearing device can include a storage unit for storing the frequency of the feedback events occurring within a pre-specifiable second period of time and an output unit for outputting the stored frequency.

The hearing device can furthermore be a hearing aid having at least one microphone and at least one earpiece.

Further specifics and advantages of the invention will become apparent from the following explanations of several exemplary embodiments presented with the aid of various schematics:

FIG. 1: is a block diagram of a hearing aid having feedback suppression according to the prior art,

FIG. 2: is a block diagram of a hearing aid having inventine feedback suppression, and

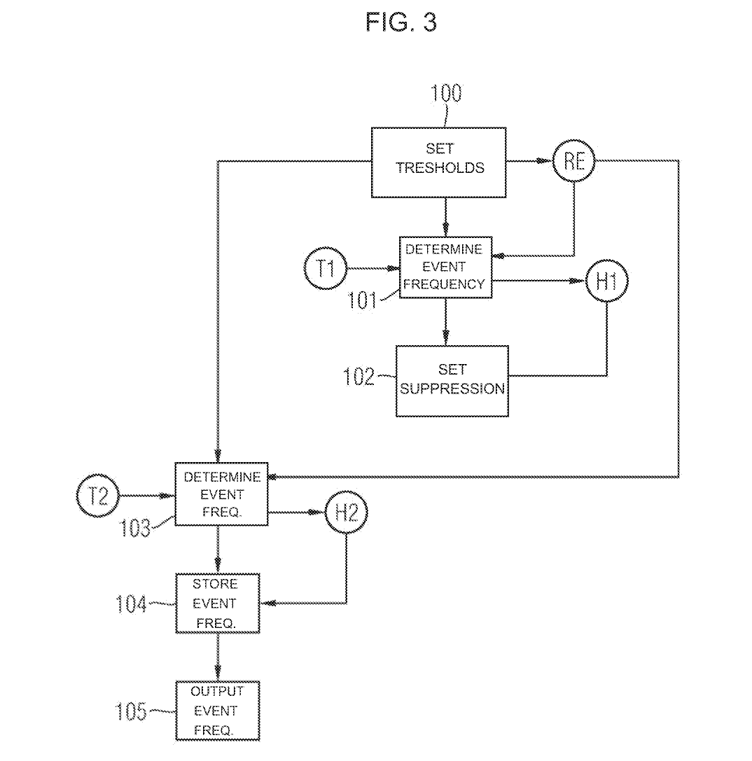

FIG. 3: is a flowchart of an inventive method for setting feedback suppression.

FIG. 2 is a block diagram of a hearing aid 1 having a microphone 2 for converting sound signals into an electric microphone signal, a signal-processing unit 6 that inter alia amplifies the microphone signal and feeds it to earpiece 3 as an earpiece signal. The electric earpiece signal is converted back into a sound signal in earpiece 3 and ducted to a hearing-aid wearer's eardrum.

Hearing aid 1 includes a feedback-suppression unit 10 for suppressing instances of feedback between earpiece 3 and microphone 2. From the earpiece signal, feedback-suppression unit 10 generates a compensation signal which, inverted, is added to the microphone signal with the aid of adder 7. Feedback artifacts can be suppressed thereby. Feedback-suppression unit 10 is controlled by a feedback-detection unit 11. The latter controls an adaptive filter in feedback-suppression unit 10 in keeping with, for example, the occurrence of feedback instances.

Feedback-suppression unit 10 has four pre-optimized parameter sets that make a setting possible that is matched to the specific feedback situation. For example a fast change in a feedback path calls for feedback suppression that can be changed quickly, whereas a slow change in the feedback path calls only for feedback suppression that can be changed slowly.

A suitable parameter set is selected by inventively counting feedback events within a pre-specifiable first period of time. The feedback events occurring, for example, above a pre-specified feedback threshold are for that purpose determined in an event unit 12 linked to feedback-detection unit 10. The frequency of the feedback events within the pre-specifiable first period of time is determined in a computing unit 13 and forwarded to a regulating unit 14 which selects one of the four pre-optimized parameter sets of feedback-suppression unit 10 in accordance with the frequency that has been determined.

The frequency of the feedback events that have been determined within a second period of time—which can be, for example, the length of time between two visits to a specialist in hearing-aid acoustics—is stored in a storage unit 15 and fed out as required via an output unit 16.

The invention can of course be used also for hearing devices other than hearing aids.

Shown in FIG. 3 is a flowchart of the inventive method for setting feedback suppression. Feedback events RE where feedback suppression starts operating and/or where feedback is detected above a pre-specifiable feedback threshold are determined at step 100. The frequency H1 of the feedback events RE within a pre-specifiable first period of time T1 is determined at ensuing step 101. Feedback suppression in accordance with the frequency H1 of the feedback events RE is then set at step 102. Pre-optimized parameter sets are used for setting feedback suppression.

The pre-optimized parameter sets can include feedback-suppression settings having different intensities of feedback reduction and different sound qualities. If the frequency H1 of the feedback events RE exceeds a specific threshold, for example, then a parameter set having a more intense feedback effect but a poorer sound quality will be selected. If the frequency H1 has fallen below a specific threshold, then a parameter set having better sound quality but a reduced feedback effect will be selected.

The frequency H2 of the feedback events RE within a pre-specifiable second period of time T2 is determined at step 103. The frequency H2 of the feedback events RE occurring within the pre-specifiable second period of time T2 is thereafter stored at step 104 and outputted if required at step 105. It is outputted for example on the premises of a specialist in hearing-aid acoustics.

### LIST OF REFERENCES

1 Hearing aid
2 Microphone
3 Earpiece
4 Feedback path
5 Adaptive filter
6 Signal-processing unit
7 Adder
8 Acoustic useful signal
9 Acoustic signal
10 Feedback-suppression unit
11 Feedback-detection unit
12 Event unit
13 Computing unit
14 Regulating unit
15 Storage unit
16 Output unit
100 Determining feedback events RE
101 Determining the frequency H1
102 Setting feedback suppression
103 Determining the frequency H2
104 Storing the frequency H2
105 Outputting the frequency H2
H1, H2 Frequency
T1 First period of time
T2 Second period of time
RE Feedback event

1-10. (canceled)

11. A method for setting feedback suppression in a hearing device, the method which comprises:
determining feedback events in the hearing device;
determining a frequency of the feedback events within a predetermined first period of time; and
setting feedback suppression by way of a pre-optimized parameter set selected in accordance with the frequency of the feedback events.

12. The method according to claim 11, wherein the feedback events are defined as events where feedback suppression starts operating or where feedback is detected above a pre-specifiable feedback threshold.

13. The method according to claim 11, which further comprises:
determining a frequency of the feedback events within a predetermined second period of time;
storing the frequency of the feedback events occurring within the predetermined second period of time; and
outputting the frequency stored in the storing step.

14. A computer-program product, comprising a computer program with software code for executing the method according to claim 11 when the computer program is loaded into a control unit of a hearing device.

15. A hearing device, comprising:
a feedback-suppression unit configured to start operating when acoustic feedback occurs;
an acoustic feedback-detection unit;
an event unit for determining feedback events in the hearing device;
a computing unit connected to said event unit for determining a frequency of the feedback events within a prespecified first time period; and
a closed-loop control unit for adjusting said feedback-suppression unit using a pre-optimized parameter set selected in accordance with the frequency of the feedback events.

16. The hearing device according to claim 15, where the feedback events are events causing the feedback-suppression unit to start operating and/or where said feedback-detection unit detects feedback above a predetermined feedback threshold.

17. The hearing device according to claim 15, further comprising:
a storage unit for storing a frequency of the feedback events occurring within a prespecified second time period; and
an output unit for outputting the frequency stored in said storage unit.

18. The hearing device according to claim 15, wherein the hearing device is a hearing aid having at least one microphone and at least one earpiece.
